(19) United States
(12) Patent Application Publication
(10) Pub. No.: US 2017/0313378 A1
(43) Pub. Date: Nov. 2, 2017

(54) BICYCLE CRANK AXLE TORQUE MODULATION DEVICE AND PROCESS FOR TUNING A TORQUE GENERATED BY THE DEVICE

(71) Applicant: SAFETRUST- ENGENHARIA E GESTAO LDA, VENDAS NOVAS (PT)

(72) Inventors: JOAQUIM MACHADO ABRANTES PERFEITO, CARVOEIRA (PT); FRANCISCO MANUEL CARNEIRO RODRIGUES, VENDAS NOVAS (PT); JOAO PAULO TORRES PANTALEAO DE NORONHA, Vendas Novas (PT)

(73) Assignee: SAFETRUST-ENGENHARIA E GESTAO LDA, VENDAS NOVAS (PT)

(21) Appl. No.: 15/531,017

(22) PCT Filed: Dec. 4, 2015
(86) PCT No.: PCT/PT2015/050012

§ 371 Date: May 26, 2017

(30) Foreign Application Priority Data
Dec. 4, 2014 (PT) 108079

(51) Int. Cl. B62M 3/06; B62M 3/00; F16H 25/14; F16H 53/06; F16H 53/04

(52) U.S. Cl. CPC B62M 3/06; F16H 53/06; F16H 53/04; B62M 3/003; F16H 25/14; B62M 2003/006

(57) ABSTRACT

The present invention relates to a bicycle crank axle torque modulation device (1), comprising a bracket (3) including a spring-bearing assembly (4), wherein each end of the spring (7) thereof is connected to each of the bearings (6) by a connection member (8); an eccentric surface (5) for driving said spring-bearing assembly (4), which is in permanent contact with the bearings (6) of said spring-bearing assembly (4), wherein one of the bracket (3) and the eccentric surface (5) is arranged to be attached to a bicycle frame and the other to be attached to said bicycle crank axle. The invention further relates to a torque tuning process, a kit comprising a crank axle and the modulation device, and to a bike including the same.

### FIELD OF THE INVENTION

The present invention relates to a bicycle crank axle torque modulation device, which allows managing the power that is delivered by a cyclist to the crank axle of a bicycle through the pedals and arms of the crank, retaining at the same time, without significant losses, the whole power generated by said cyclist. The invention further relates to a process for tuning a torque of a bicycle crank axle by synchronizing the torque applied by a given cyclist to a bicycle crank axle with the torque generated by the device of the invention in said crank axle. The invention is applicable in the transport field, particularly in the field of production and marketing of bicycles.

### BACKGROUND OF THE INVENTION

It is known that the process of pedaling a bicycle involves the application of different forces by a cyclist, therefore turning into a varying force system. That is, the force applied by a cyclist to the pedals of a bicycle and which is transmitted through the arms of the crank to the bicycle crank axle varies significantly for a complete cycle of rotation of the crank axle (a loop of 360°) due to the geometry and ergonomics of the bicycle-cyclist set.

Thus, the torque delivered by the cyclist to the crank axle over a rotation cycle will tend to be higher in a better ergonomic situation, that is, when “pushing the pedal down” and will be lower in a less favorable ergonomic situation, that is when “pushing the pedal forward/pulling pedal back.”

This non-uniformity of the torque on the crank axle generates peaks, which are compensated by an additional effort from the cyclist. A good pedaling is characterized by its efficiency. The efficiency is directly related to the pace that the cyclist uses when pedaling. Usually, an inexperienced cyclist is less efficient than an experienced cyclist, using a lot more power to maintain the same speed and/or acceleration. Typically cyclists work to reduce the low torque sectors (“pushing pedal forward/pulling pedal back”) in the crank axle by using training techniques and monitoring technologies.

It is known the use, on bicycles, of aid systems for the pedaling process for decreasing the cyclist's effort. Such devices store some of the energy provided by the cyclist in the angular region, or corresponding sector to “push the pedal down”, where, due to a more favorable ergonomics, the cyclist is able to produce a movement with such power and less effort.

In this context, CN 2092486 discloses a power management device for a bicycle, comprising a cam arranged on the crank axle, a rocker arm having a bearing in contact with said cam, and a tension spring attached to the bicycle frame at one end thereof and attached to the rocker arm at its other end. Thus, when the pedal is positioned in a region with a phase angle favorable to the application of force by the cyclist, the cam radius is larger to permit to store energy in the spring, and when the pedal is positioned in a region where the phase angle is unfavorable to the application of force by the cyclist, the radius of the eccentric cam is smaller, which allows the release of the stored energy during the favorable phase by the spring. A portion of this stored energy is transferred to the crank axle while the other portion is applied on the bicycle frame, on which said tension spring is attached. A reduction of the cyclist's effort is thus obtained.

Although the document cited above discloses a device which provides an increased torque of a bicycle crank axle in the unfavorable angular sector, thereby reducing the force applied by a cyclist to the bicycle pedals, said device shows only a limited improvement in the cyclist performance. In fact, the device disclosed in the above mentioned document only takes advantage of half the spring energy capacity as consequence of the fixed end on the bicycle frame.

In accordance with the foregoing, there is a need in the art for a device allowing, in a simple manner, a significant improvement of the cyclist's performance by reducing the effort employed in the pedaling process, wherein the stored energy can be transferred in its entirety to the crank axle so as to increase the torque of a crank axle.

There is also a need in the art for a device allowing, in addition to the above object, synchronizing the torque applied by a cyclist to a crank axle with the torque generated by said device, in order to customize the device performance for each user.

### SUMMARY OF THE INVENTION

The present invention relates to a bicycle crank axle torque modulation device (1), said device comprising:
a bracket comprising a spring-bearing assembly;
an eccentric surface for driving said spring-bearing assembly, wherein said eccentric surface is in permanent contact with the bearings of said spring-bearing assembly, said eccentric surface and said spring-bearing assembly being rotationally moveable to each other;

wherein one of said bracket or eccentric surface is arranged to be attached to a bicycle frame and the other to be attached to the crank axle of the bicycle,

characterized in that the spring-bearing assembly comprises at least one spring connected to at least two radial bearings, wherein each end of said at least one spring is connected to at least one radial bearing by means of a connection member.

In one embodiment, the connection member is an arm.

In a preferred embodiment, said spring-bearing assembly comprises two springs, parallel to each other, connected to two radial bearings.

Preferably, the spring-bearing assembly is connected to the bracket by means of linear bearings.

In one aspect of the present invention, the arm connecting the spring end to the one or more radial bearings, is connected to the bracket by means of at least one linear bearing.

In another aspect, said arm holds at least one radial bearing by means of a pin.

In yet another aspect, said arm receives at least one spring end by means of at least one adjustment screw.

In a further embodiment, said eccentric surface is arranged to rotate relative to the bracket, the latter being stationary.

In another further embodiment, the bracket is arranged to rotate relative to the eccentric surface, the latter being stationary.

In yet another aspect, said eccentric surface is an inner surface of a rotor.

Most preferably, said rotor is fitted on the radial bearings in the bracket, and it is arranged to be connected to the bicycle crank axle, wherein the inner eccentric surface of the rotor is in permanent contact with the bearings of the spring-bearing assembly provided in the bracket.

The present invention further relates to a process for tuning a torque of a bicycle crank axle, the process characterized in that comprises the steps of:

i) angularly varying the position of an eccentric surface of a device of the invention relative to a bicycle crank axle position so as to synchronize the torque applied by a cyclist to a crank axle with the torque generated by said device;

ii) attaching the eccentric surface to the crank axle.

Preferably, the tuning process comprises the steps of i) angularly varying the position of a rotor having an eccentric surface relative to the position of said radial bearings of a spring-bearing assembly; and ii) attaching said rotor to the crank axle.

In another embodiment, the torque tuning process comprises the steps of:

i) angularly varying the position of a bracket of a torque modulation device of the invention relative to a bicycle frame;

ii) attaching the bracket to the bicycle frame.

The present invention further relates to a kit comprising a crank axle and the bicycle crank axle torque modulation device.

The invention also relates to bicycle comprising the bicycle crank axle torque modulation device.

### BRIEF DESCRIPTION OF THE DRAWINGS

In the following the invention will be described with reference to the accompanying drawings, wherein:

FIG. 1 shows different effort stages of a cyclist during a crank axle rotation cycle of a bicycle.

FIG. 2 shows a schematic embodiment of a set formed by the spring-bearing assembly and eccentric surface of the device of the present invention, as well as depicting the radial forces and tangential forces involved in the operation of the set.

FIG. 3 is a schematic view of a preferred embodiment of the invention.

FIG. 4 shows an exemplary configuration of the spring-bearing assembly with two springs, parallel to each other, connected to two radial bearings.

FIG. 5 shows an exemplary embodiment of a rotor, showing an inner eccentric surface.

FIG. 6 is a schematic view of a kit of the invention comprising the modulation device and a crank axle.

FIG. 7 is a partial schematic view of a bicycle comprising a modulation device according to the present invention.

FIG. 8 shows a torque graph depicting synchronized torques.

FIG. 9 shows a torque graph depicting non synchronized torques.

FIG. 10 shows a graph depicting resulting torques from different spring pre-compressions of the spring-bearing assembly.

### DETAILED DESCRIPTION THE INVENTION

The present invention relates to a bicycle crank axle torque modulation device, and to a tuning process for the torque generated by said device. This invention allows, in a simple way, to take the most out of the spring compression energy, thus maximizing the tangential forces exerted on an eccentric surface, allowing higher torques to be achieved in the crank axle of the bicycle.

The present invention provides a significant advantage relative to prior art devices which only have a free spring end. Indeed the device of the present invention provides a balance to bending forces on the crank axle and takes the most out of the entire energy capacity of the spring or springs, overcoming the issue of the fixed end on the bicycle frame and the existence of residual deformations that impair the cyclist's performance.

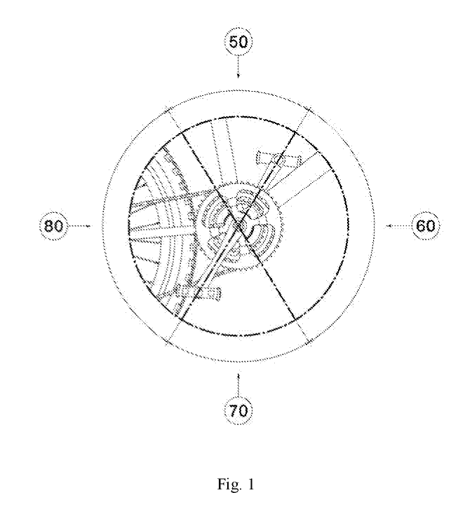

With reference to FIG. 1 and as already mentioned above, during a rotation cycle (a 360 degrees loop), the modulation device stores a portion of the energy delivered by the cyclist in the angular region where, due to a more favorable ergonomics, the cyclist is able to generate this energy more easily and effectively, “pushing the pedal down,” in sectors (60, 80). The energy stored by the spring or springs will be returned by the device in the angular sector where, due to a less favorable ergonomics, the cyclist is less efficient and has greater difficulty in producing energy, “pushing pedal forward/pulling pedal back”, in sectors (50, 70). Thus, the torque will be more uniform since the low value of the torque between energy peaks, which is usually observed during the crank axle rotation cycle, is partially compensated using a portion of the energy generated at the energy peaks.

If the bike does not have a crank axle torque modulation device, the non-uniformity of torque in said crank axle is compensated/counteracted by an additional effort from the cyclist in sectors (50.70). How to angularly reduce the low torque sectors (50, 70) in the crank axle is usually an object pursued by cyclists using training techniques and monitoring technologies, whereby the crank axle torque modulation device can create a way for a better performance than currently achieved by all cyclists, amateurs and professionals.

With this device, the torque on the crank axle of a bicycle is more uniform, since the low value of the torque between energy peaks (that is, in sectors (50, 70)), which is usually observed during the rotation cycle of the crank axle, is partially compensated using a portion of the energy produced at the power peaks (sectors (60, 80)).

More specifically it has been surprisingly found that using a spring-bearing assembly that does not require a connection of a spring or springs to the bicycle frame further reduces the effort delivered by the cyclist while pedaling, improving the balance of bending forces on the crank axle. In prior art devices an induction of residual deformations which impaired the cyclist performance was observed, since a portion of the energy expended was used to deform the crank axle by bending.

The solution of the present invention provides the additional effect of making the entire system more compact when compared to the solution presented in CN 2092486 and similar prior art solutions. The possibility of integration with the crank axle as an accessory part allows providing a torque modulation function, thereby minimizing the disadvantages related to bulk and weight of a prior art device, which makes this device useful for use as an accessory part to any bike, allowing its use without requiring any changes to conventional bicycle manufacturing methods and assembly.

An object of the present invention is thus to provide a bicycle crank axle torque modulation device which allows the cyclist to have a better performance by means of a better use of the force applied by the cyclist in the sectors (60, 80) of the crank axle rotation cycle, depicted in FIG. 1.

In the context of present invention, the term “torque” relates to the multiplication of a force by the distance from the point of application of said force to an axle, which causes rotation on said axle.

The term “spring” relates to an element for storing potential energy and observing the Hooke's law of elasticity. By way of example, springs selected from the set comprising helical springs, coils, spiral springs, leaf springs, flexible rim springs and the like, and combinations thereof, can be used in the present invention.

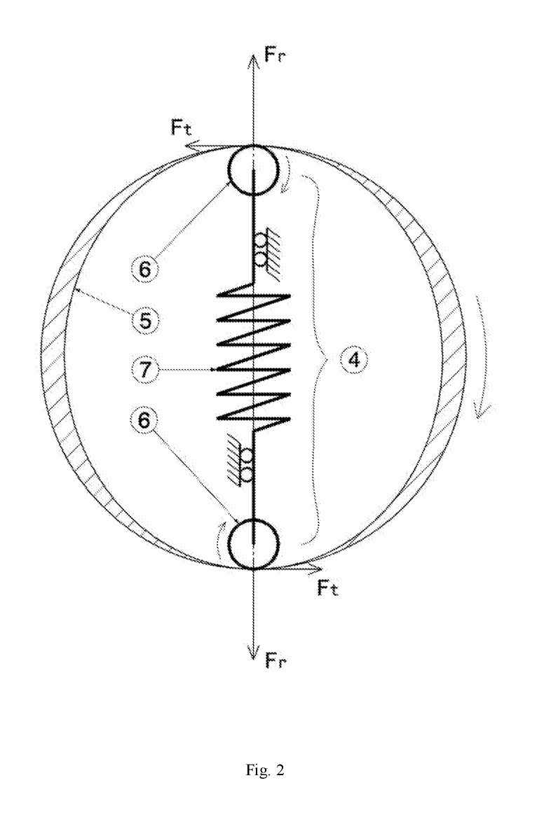

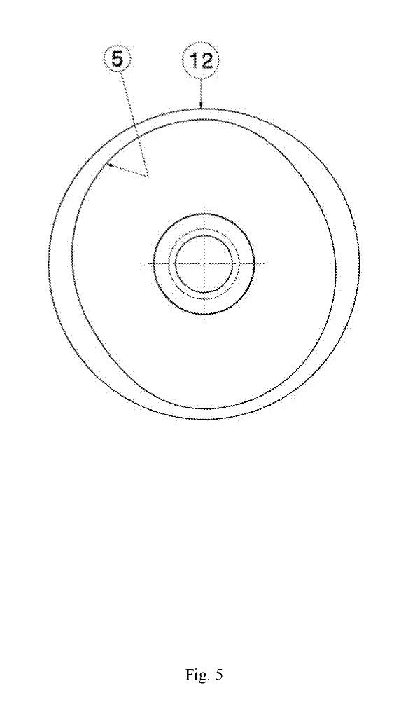

The term “eccentric surface” relates to a closed surface of a ring type having a non-circular shape. An example of eccentric surface according to the invention is illustrated in FIGS. 2 and 5 with numeral reference (5).

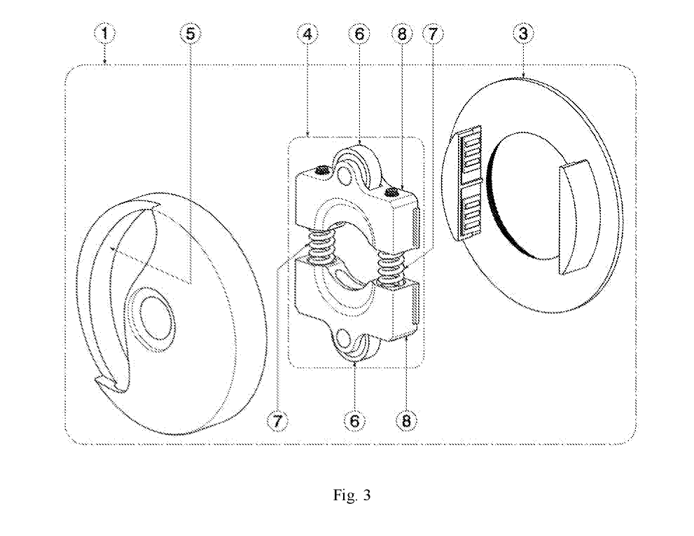

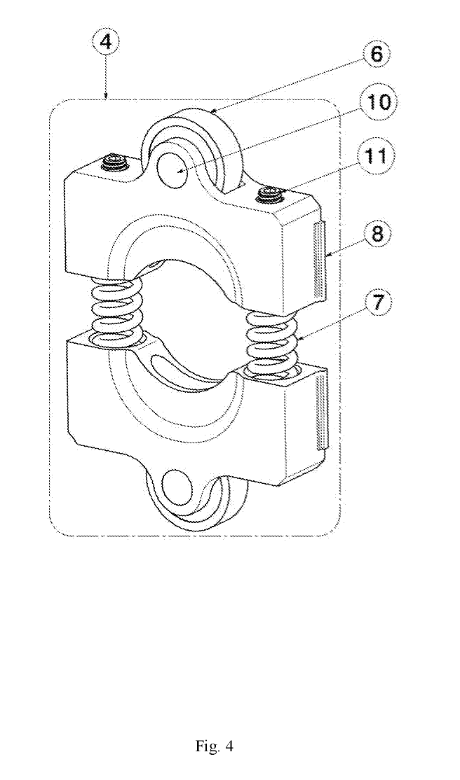

The term “spring-bearing assembly” relates to a set formed by at least one spring connected at each of the ends thereof to at least one radial bearing. Said connection between the spring end and the at least one bearing may be carried out by any connection member (8) known in the art, for example an arm (such as shown in FIGS. 3 and 4).

The term “rotor” relates to a rotatable member comprising an eccentric surface (5) therein. This member can have any shape which enables it to be fitted on the radial bearings (6) of the spring-bearing assembly (4), so that the eccentric surface is in permanent contact with said bearings (6). The rotor is connected to the crank axle, rotating together with the latter and driving the bearings (6) from the spring-bearing assembly (4) by means of the eccentric surface (5). The rotor may have any suitable shape, such as, for example, spherical calotte, annular, cylinder among others or combinations thereof, provided that it comprises an eccentric inner surface.

The expression “angularly varying the position of a rotor” means that the rotor can move with one rotation freedom degree relative to the crank axle rotation axis.

In the context of the present description, the term “comprising” should be construed as “including among others”. As such, said term should not be construed as “consisting only of”.

In the present application, the use of the term “and/or” is intended to mean that both conditions occur or only one occurs. For example, the expression “speed and/or acceleration” means “speed and acceleration or speed or acceleration.”

With reference to FIGS. 2 to 5, the present invention relates to a bicycle crank axle torque modulation device (1), wherein the device (1) comprises:
a bracket (3) comprising a spring-bearing assembly (4);
an eccentric surface (5) for driving said spring-bearing assembly (4), wherein said eccentric surface (5) is in permanent contact with the bearings (6) of said spring-bearing assembly (4), and said eccentric surface (5) and spring-bearing assembly (4) are rotationally moveable to each other;

wherein one of said bracket (3) or eccentric surface (5) is arranged to be attached to a bicycle frame and the other to be attached to the crank axle (2) of the bicycle, and

the spring-bearing assembly (4) comprises at least one spring (7) connected to at least two radial bearings (6), wherein each end of said at least one spring (7) is connected to at least one radial bearing (6) by means of a connection member (8).

In a preferred embodiment, the spring-bearing assembly (4) comprises two springs (7), parallel to each other, connected to two radial bearings (6). This arrangement allows obtaining a better balance of bending forces on the bicycle crank axle (2).

Of course only one spring (7) could be used, connected at each the ends thereof to at least one radial bearing (6).

A greater number of springs (7) on the spring-bearing assembly (4) can also be used provided that both ends of each spring are connected to at least one radial bearing (6). These arrangements with several springs allow to establish at least two contact pairs between the eccentric surface (5) and the radial bearing (6). As used herein a contact pair is defined by the set made of bearing and eccentric surface, whereby the reference to “N contact pairs” means that N bearings are in contact with an eccentric surface.

The spring-bearing assembly (4) can be connected to bracket (3) by means of linear bearings (9). This connection solution allows to have both ends of the springs (7) available for connection to the radial bearings (6).

The connection between the springs (7) and the radial bearings (6) can be achieved by any suitable means known to skilled person, wherein in one embodiment of the invention said connection member (8) is an arm.

In one aspect of the invention, each of said arms is connected to the bracket (3) by means of at least one linear bearing (9), thus allowing connecting the whole spring-bearing assembly (4) to the bracket (3).

Preferably, the arm holds at least one radial bearing (6) by means of a pin (10) and receives at least one spring end (7) by means of an adjustment screw (11).

As to said eccentric surface (5), it can be arranged for rotating in relation to the bracket (3), the latter being stationary; otherwise the bracket (3) can be arranged to rotate in relation to the eccentric surface (5), the latter being stationary.

Preferably, said eccentric surface (5) is an inner surface of a rotor (12), such as illustrated in FIGS. 3 and 5, and defined above.

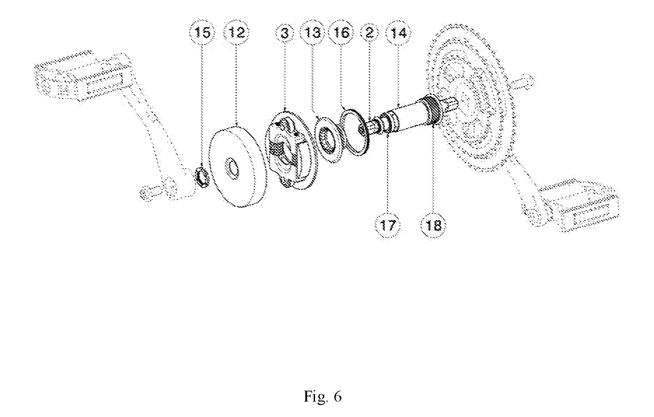

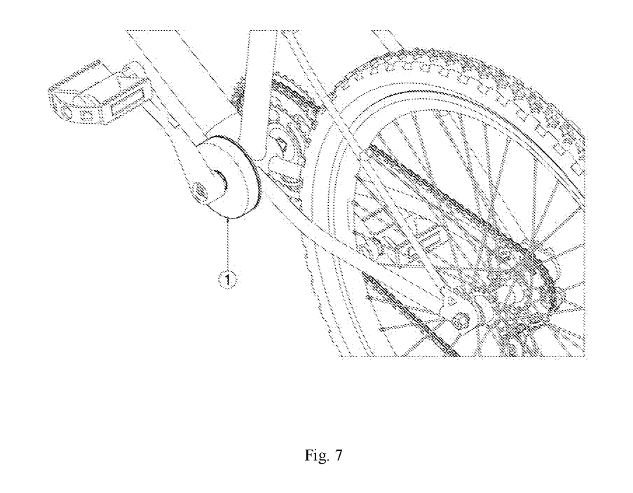

In a preferred embodiment, the rotor (12) is fitted on the radial bearings (6) in the bracket (3) and it is arranged to be connected to the bicycle crank axle (2), using crank axle radial bearings (17) for connection and rotation relative to the housing (14), wherein the eccentric inner surface (5) of the rotor (12) is in permanent contact with bearings (6) of the spring-bearing set (4) arranged on the bracket (3). FIG. 6 shows an exploded view of the assembly of the preferred device (1) of the invention, and FIG. 7 shows a device (1) of the invention mounted on a bicycle.

Regarding the operation of the device (1) of the present invention, the cyclist, when cycling through sectors (60, 80) shown in FIG. 1, corresponding to “pushing the pedal down”, will generate a torque which will be partly stored in the device (1) as potential energy of elasticity by means of compression of the one or more springs (7). When the cyclist cycles through sectors (50, 70) shown in FIG. 1, corresponding to “pushing the pedal forward/pulling the pedal back”, the potential energy of elasticity that was previously stored by the spring(s) (7) at sectors (60, 80) will be delivered to the crank axle (2) as an additional torque.

The successive cycles of compression and subsequent decompression of springs (7), which are supported by connection members (8), for example arms, by means of adjustment screws (11), are carried out by the rotor (12) linked to the crank axle (2), which is mounted so that the radial bearings (6) are in contact with an eccentric surface (5) within the rotor (12). The way the radial bearings (6) run through the eccentric surface (5) of rotor (12), combined with the fact that the radial bearings (6) are integral with arms (8) and these are constrained to only one translation freedom degree in both directions, will cause said arms (8) to be spaced apart or to be brought closer one to another.

The inner geometry of the rotor (12), that is the eccentric surface (5), is designed for an angle of 0 to 180 degrees and repeated from 180 to 360 degrees thereby constituting a full angle range of 0 to 360 degrees (see FIG. 5).

The design of two contact pairs between the rotor (12) and two radial bearings (6), mounted in opposition to each other, as in a mirror relative to a crank axle (2), allows an appropriate balance of forces, as well as a greater storage of potential energy of elasticity due to duplication of the forces involved. It also allows to reduce the mechanical stress of the components and to obtain a more compact system. The lower mechanical stress and better balance caused by this solution enables deformation, wear and fatigue of the components to be substantially reduced.

With reference to FIG. 2, the force exerted by the radial bearings (6) against the eccentric surface (5) within the rotor (12) will induce a radial component and a tangential component in the contact area between the rotor (12) and the radial bearing (6). The radial component will be eliminated by the opposite reaction with the same absolute value of said two contact pairs. Said tangential component will induce a torque on the crank axle (2) which will depend on the geometry of the eccentric surface (5) within the rotor (12) and it will be multiplied by two due to the existence of two contact pairs.

In a preferred embodiment according to FIGS. 3 and 4, the radial bearings (6) which yield the force transfer, are supported by two arms (8) which in turn are guided by linear bearings (9) on the bracket (3). The spring-bearing assembly (4) remains always pressed against rotor (12) by means of two springs (7). The value of this compression will vary according to the geometry of the inner eccentric surface (5) of rotor (12) and the adjustment of pre-compression of springs (7).

The present invention also relates to a process for tuning a torque of a bicycle crank axle (2), wherein the tuning process comprises the steps of:

i) angularly varying the position of an eccentric surface (5) of a device (1) according to the invention relative to the position of a bicycle crank axle (2) and/or angularly varying the position of the bracket (3) of a device (1) of the invention relative to the bicycle frame so as to synchronize the torque applied by a cyclist to a crank axle (2) with the torque generated by said device (1); and

ii) attaching together the eccentric surface (5) to the crank axle (2) and attaching together the bracket (3) to the bicycle frame, so that said eccentric surface (5) is able to rotate relative to radial bearings (6) of said spring-bearing assembly (4); optionally said eccentric surface (5) can be attached to the bicycle frame and the bracket (3) can be attached to the crank axle (2) for allowing the rotation between the radial bearings (6) of the spring-bearing assembly (4) and the eccentric surface (5).

In a preferred embodiment of the tuning process according to the invention, the process comprises the steps of:

i) angularly varying the position of a rotor (12) having an eccentric surface (5) relative to the angular position of the crank axle (2); and

ii) attaching said rotor (12) to the bicycle crank axle (2), for example by means of a retention ring (15).

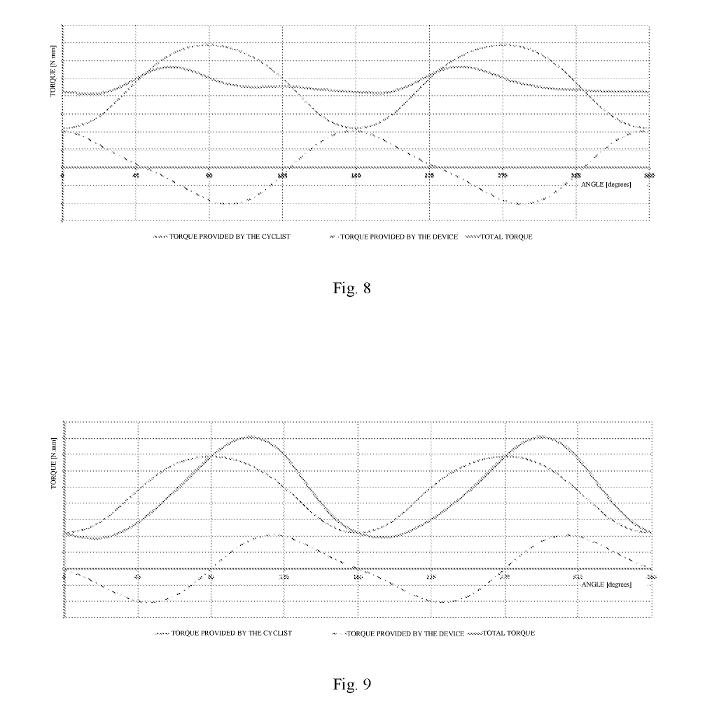

By means of the tuning process of the invention it is intended to synchronize the device (1) and the cyclist by mounting said eccentric surface (5) or the rotor including it, or even said bracket (3), and adjusting them angularly so as to position appropriately the device (1) relative to the cyclist which will use it. In FIGS. 8 and 9 examples of effects of a correct synchronization between cyclist and device (FIG. 8), and of an incorrect synchronization (FIG. 9) therebetween is depicted. As can be seen, the incorrect synchronization has an effect that may be unwanted and even harmful towards the intended object, compared with non-using the device (1) of the invention.

The influence of the device (1) on the total torque can be also adjustable by modifying the pre-compression of springs (7). Such pre-compression can be adjusted by means of adjustment screws (11) screwed into the connection member (8) (for example, arm), when the adjustment screws (11) are screwed into or unscrewed from the connection member (8). Therefore, one pre-compression adjustment system can be provided for each spring (7) of the device (1) of the invention.

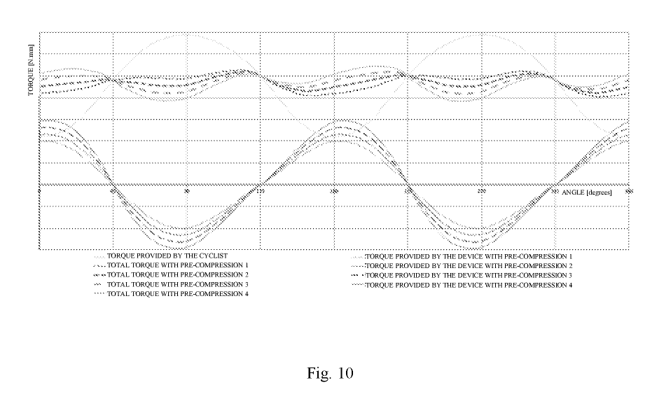

In FIG. 10 an example is shown of the effect of different pre-compressions of springs (7) from a set of two springs (7) and two radial bearings (6), taking into account that pre-compression of both springs (7) is identically adjusted and that there is a perfect synchronization between cyclist and device (1).

The present invention further relates to a kit comprising a crank axle (2) and the device (1) as described above.

The invention also relates to a bicycle comprising the device (1) described above.

The device of the present invention can be installed on left hand side, right hand side or both sides of the crank axle, while maintaining the same principles described herein. By way of example, in the present disclosure, the device is shown mounted on the left hand side of the bicycle, see FIG. 7.

### EXAMPLE

With reference to FIG. 6, for being able to be applied to a bicycle, the device (1) is provided with a typical bicycle attachment system, with its attachment being made by screwing cups (13, 18) on both sides of the bicycle housing (14), thereby observing industry standards.

The cup (13), in addition to the aforementioned function of attachment of the device to a side of the housing (14), also has the function of positioning the bracket (3) which, in turn, is attached by screwing a retention ring (16).

The bracket (3) is provided with two lateral supports for supporting four linear bearings (9) (FIGS. 3 and 4). On the linear bearings (9) two arms (8) are mounted so that they are linearly guided in only one direction within the bracket (3).

In each arm (8) a radial bearing (6) is mounted by means of a pin (10).

In each arm (8) two adjustment screws (11) that will serve as support to compression springs (7) are screwed.

On the crank axle (2) a rotor (12) is positioned which, in turn, is held by means of the retention ring (15).

The inner eccentric surface (5) of rotor (12) is in contact with the two radial bearings (6).

The description herein shall be understood as exemplary and not limiting the scope of the present invention, which is defined in the appended claims.

1. A bicycle crank axle torque modulation device (1), the device (1) comprising:
a bracket (3) comprising a spring-bearing assembly (4);
an eccentric surface (5) for driving the spring-bearing assembly (4), wherein said eccentric surface (5) is in permanent contact with the bearings (6) of the spring-bearing assembly (4), the eccentric surface (5) and the spring-bearing assembly (4) being rotationally moveable to each other;
wherein one of said bracket (3) or eccentric surface (5) is arranged to be attached to a bicycle frame and the other to be attached to the crank axle (2) of the bicycle,
characterized in that the spring-bearing assembly (4) comprises at least one spring (7) connected to at least two radial bearings (6), wherein each end of said at least one spring (7) is connected to at least one radial bearing (6) by means of a connection member (8).

2. The device (1) according to claim 1, wherein the spring-bearing assembly (4) comprises two springs (7), parallel to each other, connected to two radial bearings (6).

3. The device (1) according to claim 1 wherein the spring-bearing assembly (4) is connected to the bracket (3) by means of linear bearings (9).

4. The device (1) according to claim 1, wherein said connection member (8) is an arm.

5. The device (1) according to claim 4, wherein said arm is connected to bracket (3) by means of at least one linear bearing (9).

6. The device (1) according to claim 4, wherein said arm holds at least one radial bearing (6) by means of a pin (10).

7. The device (1) according to claim 4, wherein said arm receives at least one spring end by means of at least one adjustment screw (11).

8. The device (1) according to claim 1, wherein said eccentric surface (5) is arranged to rotate relative to bracket (3), the latter being stationary.

9. The device (1) according to claim 1, wherein bracket (3) is arranged to rotate relative to the eccentric surface (5), the latter being stationary.

10. The device (1) according to claim 1, wherein said eccentric surface (5) is an inner surface of a rotor (12).

11. The device (1) according to claim 10, wherein said rotor (12) is fitted on the radial bearings (6) in the bracket (3), and in that the rotor (12) is arranged to be connected to the bicycle crank axle (2), wherein the eccentric inner surface (5) of rotor (12) is in permanent contact with the bearings (6) of the spring-bearing assembly (4) arranged in the bracket (3).

12. A process for tuning a torque of a bicycle crank axle (2), the process characterized in that it comprises the steps of:
i) angularly varying the position of an eccentric surface (5) of a device (1) as claimed in any of claims 1 to 11, relative to a position of the bicycle crank axle (2) so as to synchronize the torque applied by a cyclist to the crank axle (2) with the torque generated by said device (1);
ii) attaching the eccentric surface (5) to the crank axle (2).

13. The tuning process according to claim 12, comprising the steps of:
i) angularly varying the position of a rotor (12) having an eccentric surface (5) relative to the position of the crank axle (2);
ii) attaching said rotor (12) to the crank axle (2).

14. A process for tuning a torque of a bicycle crank axle (2), the process characterized in that it comprises the steps of:
i) angularly varying the position of a bracket (3) of a torque modulation device (1) as claimed in 1, relative to a bicycle frame;
ii) attaching the bracket (3) to the bicycle frame.

15. A kit comprising a crank axle (2) and the device (1) of claim 1.

16. A bicycle comprising the device (1) of claim 1.
